(19) United States
(12) Patent Application Publication
(10) Pub. No.: US 2020/0206084 A1
(43) Pub. Date: Jul. 2, 2020

(54) Attachable portable pill dispenser and associated system and method for compliance with medication regimen.

(71) Applicant: Konstantin Tsukanov, Pacheco, CA (US)

(72) Inventor: Konstantin Tsukanov, Pacheco, CA (US)

(21) Appl. No.: 16/712,859

(22) Filed: Dec. 12, 2019

Related U.S. Application Data
(60) Provisional application No. 62/785,080, filed on Dec. 26, 2018.

(51) Int. Cl. A61J 7/00; A61J 1/03; A61J 7/04; G08B 21/24

(52) U.S. Cl. CPC A61J 7/0076; A61J 1/03; A61J 7/0481; A61J 2200/30; A61J 7/0454; G08B 21/24; A61J 7/0084

(57) ABSTRACT

A portable dispenser for assorted pills or other items. The dispenser is compatible with a generic pill vial with reversible cap. The dispenser is attachable to a pill vial with reversible cap, so that the dispenser becomes associated with the whole pill vial and can be detached from the vial to accommodate a prepared dosage of pills, enabling the user to carry them without having to carry the entire pill vial. The portable dispensers can be attached to each other and are combinable with a system and method for tracking recommended doses and regimens for dispensing medication or other items stored in the generic pill vial. Furthermore, an electronic device with monitoring-reminder-alarming functionality can be attached to the reversible cap of the pill vial or portable dispenser, for the purpose of being integrated with the pill vial or the portable dispenser of user's choice.

### FIELD OF THE INVENTION

The invention relates to a portable dispenser for the storage of prescription or non-prescription medicine, pills, capsules, tablets, supplements, vitamins or other items. The invention also pertains to the method and system for compliance with medication regimen.

### BACKGROUND OF THE INVENTION

Many people are familiar with situations which can strain or disrupt even their best efforts to keep up a regular schedule for the ingestion of various vitamins or medications, prescribed by a doctor or taken at their discretion to maintain physical health. This is especially difficult for the elderly or for those who experience challenges with daily planning, accountability and recollection. This can also be true for people who have medications that need to be taken at various times during the day and who may need to carry their medications with them outside of their place of residence. There are several products on the market with regimen control functionality and purpose, but which have fundamental usability deficiencies—such as limited mobility, large size, complexity, lack of scale, and confined functionality—which prevent these products from being used to their best efficiency. Hence, there is a need for portable dispensers, reminders and devices that combine dispensing, reminding, mobility, portability, scalability, configurability functions in single system. Such tools, systems and methods can help people comply with medication regimens and reduce the risk of a person missing their regular dose of medication, whether while at home or during travel.

### BRIEF SUMMARY OF THE INVENTION

The present disclosure includes many aspects, elements and features. Furthermore, while many aspects, elements and features of the present disclosure relate to—and are described in—the current invention, which is described in context of a portable dispenser, attachable to a reversible cap of the pill vial, to be associated with the whole generic pill vial/medicine container, and electronic device with monitoring-reminder-alarm functionality, which is attachable either to reversible cap of the portable dispenser or to reversible cap of the generic pill vial and can be paired through wireless connection with a smartphone/computer device with software application for data exchange and remote monitoring. The portable dispenser is compatible with a pill vial with a reversible cap. The cap for the portable dispenser has the same measurements and functional parameters as the reversible cap of the generic pill vial. The dispenser can be detached from the generic pill vial/medicine container, accommodating a prepared regular dosage of pills, and can enable the user to carry a portable dispenser and to have their regular dosage of medication available with them anywhere anytime. Being associated, via its distinct color, and attached to the generic pill vial, the portable dispenser can also act as a method of monitoring and reminding: so that, when it is empty, the user realizes that it is time to refill the portable dispenser with a daily dose of items for the next day, or the user knows to bring another portable dispenser with already prepared daily dosage of pills for the next day. Some portion of the portable dispenser, preferably lower portion of the portable dispenser, is transparent to reveal to the user the presence or absence of the daily dose of items without opening the portable dispenser. Also, multiple portable dispensers can be attached to each other and can be attached to magnetic surface and can be combined into an automated electronic system for tracking recommended doses and regimens for dispensing medication or other items stored in the container. In such stackable configuration, where portable dispensers are attached to each other, every separate dispenser unit can have a distinct color and/or labeled in accordance with the day of the week or the time of the day. For example, the dispenser with the prepared dose of medicine for Monday may have a distinct color and/or label different from the dispenser with the prepared dose of medicine for Tuesday. Or, for example, the dispenser containing a prepared dose of medicine for Mornings may have a distinct color and/or label different from the dispenser with a prepared dose of medicine for Afternoons or Evenings. Furthermore, because the cap of the portable dispenser in this embodiment has the same measurements and functional parameters as the reversible cap of the generic pill vial, an electronic device with general monitoring-reminder-alarm functionality, which has threading compatible with the reversible cap's threading, can be attached to the reversible cap of the pill vial or the portable dispenser for the purpose of its integration with the generic pill vial or the portable dispenser of user's choice and to provide automated regimen tracking functionality. Moreover, an attachable electronic device with monitoring-reminder-alarm functionality can be wirelessly connected to smartphone/computer device with a software application which provides general remote automated regimen tracking and configuration functionality. There are several advantages of this medication regimen compliance system and method which, according to the present invention, could be expected to enhance a user's compliance with their prescribed medication regimen. These include system flexibility and scalability—via the inter-attachability and combined usage of the portable dispenser, the electronic device, the mobile application, and the magnetic calendar, when all of them, or some of them, are assembled into a system by being attached to each other—as well as the dispenser's portable size and form, designed for convenient operation.

### BRIEF DESCRIPTION OF THE DRAWINGS

FIG. 1 is a side elevation view of portable dispenser with one storage compartment;

FIG. 2 is a perspective view of two separate component parts of the portable dispenser with one storage compartment;

FIG. 3 is a side elevation view of assembled portable dispenser with two storage compartments;

FIG. 4 is a perspective views of three separate component parts of the portable dispenser with two storage compartments;

FIG. 5 is a side elevation view of assembled portable dispenser with one storage compartment and generic pill vial;

FIG. 6 is a perspective views of two separate component parts of the portable dispenser with one storage compartment and the generic pill vial with reversible cap;

FIG. 7 is a side elevation view of one portable dispenser and one generic pill vial assembled in stackable configuration;

FIG. 8 is a side elevation view of four portable dispensers and one generic pill vial assembled in stackable configuration;

FIG. 9 is a side elevation view of seven portable dispensers and one generic pill vial assembled in stackable configuration;

FIG. 10 is a side elevation view of assembled portable dispenser with two storage compartments with a compact electronic device component and with magnetic bottom surface;

FIG. 11 is a perspective view of four separate components of the portable dispenser with two storage compartments, with one attached electronic device and with magnetic bottom surface;

FIG. 12 is a perspective view of the generic pill vial with a compact electronic device component, where electronic device is assembled with the reversible cap which covers the vial in non-child-protection mode.

FIG. 13 is a perspective view of separate component parts of the generic pill vial with the electronic device component attachable to the generic pill vial in non-child-protection mode;

FIG. 14 is a perspective view of the portable dispenser assembled with a compact electronic device component shown wirelessly connected to a smartphone/computer device by the means of a software application;

FIG. 15 is a perspective view of the generic pill vial assembled with a compact electronic device component shown wirelessly connected to a smartphone/computer device by the means of a software application;

FIG. 16 is a side elevation view of a portable dispenser with two storage compartments, with magnetic bottom surface, without a lock or a child-protected closure mode option;

FIG. 17 is a perspective views of three separate component parts of the portable dispenser without a lock embodiment, and where one of the parts has a magnetic bottom surface;

FIG. 18 is a side elevation view of the assembled compact electronic device with a magnetic threaded adapter;

FIG. 19 is a perspective views of two separate component parts of the compact electronic device with magnetic threaded adapter;

FIG. 20 depicts a perspective views of three assembled embodiments of the portable dispenser and the compact electronic device with magnetic threaded adapter which are attachable to Calendar Magnetic Board for medication regimen tracking purposes and also shown wirelessly connected to a smartphone/computer device;

FIG. 21 depicts a connectivity diagram to illustrate the attachability of the portable dispenser and the compact electronic device to generic pill vials of three different sizes either directly or through threaded adapters.

### DETAILED DESCRIPTION

The present invention is a portable dispenser which is compatible with the generic pill vial with a reversible cap and is attachable to the reversible cap of the pill vial, thus becoming integrated with the whole generic pill vial/medicine container. The cap for the portable dispenser has the same measurements and functional parameters as the reversible cap of the generic pill vial. The dispenser can be detached from the generic pill vial/medicine container to accommodate a prepared regular dosage of pills and, thus, enabling the user to carry the portable dispenser with them and to have their regular dosage of medication available anywhere anytime. The portable dispenser can also act as a method of monitoring and reminding; so that when it is empty, the user knows to refill the portable dispenser with a daily dose of items for the next day or realizes to bring with them another portable dispenser with a prepared daily dosage of pills for the next day. Multiple portable dispensers can be attached to each other and, as such, can be combined into a system for tracking recommended doses and regimens for the dispensing of medication or of other items stored in the container. In such stackable configuration, where portable dispensers are attached to each other, every separate dispenser unit can have a distinct color and/or labeled in accordance with the day of the week or the time of the day. For example, the dispenser with the prepared dose of medicine for Monday may have a distinct color and/or label different from the dispenser with the prepared dose of medicine for Tuesday. Or, for example, the dispenser containing a prepared dose of medicine for Mornings may have a distinct color and/or label different from the dispenser with a prepared dose of medicine for Afternoons or Evenings. Furthermore, because the cap of the portable dispenser in this embodiment has the same measurements and functional parameters as the reversible cap of the generic pill vial, an electronic device with general monitoring-reminder-alarm functionality, which has threading compatible with the reversible cap's threading, can be attached to the reversible cap of the pill vial or the portable dispenser for the purpose of its integration with the generic pill vial or the portable dispenser of user's choice and to provide automated regimen tracking functionality. Moreover, an attachable electronic device with monitoring-reminder-alarm functionality can be wirelessly connected to smartphone/computer device with a software application which provides general remote automated regimen tracking and configuration functionality. Also, multiple portable dispensers can be attached to each other and can be attached to magnetic surface and can be combined into calendar magnetic board and automated electronic system wirelessly connected to smartphone/computer device with a software application for tracking recommended doses and regimens for dispensing medication or other items stored in the container.

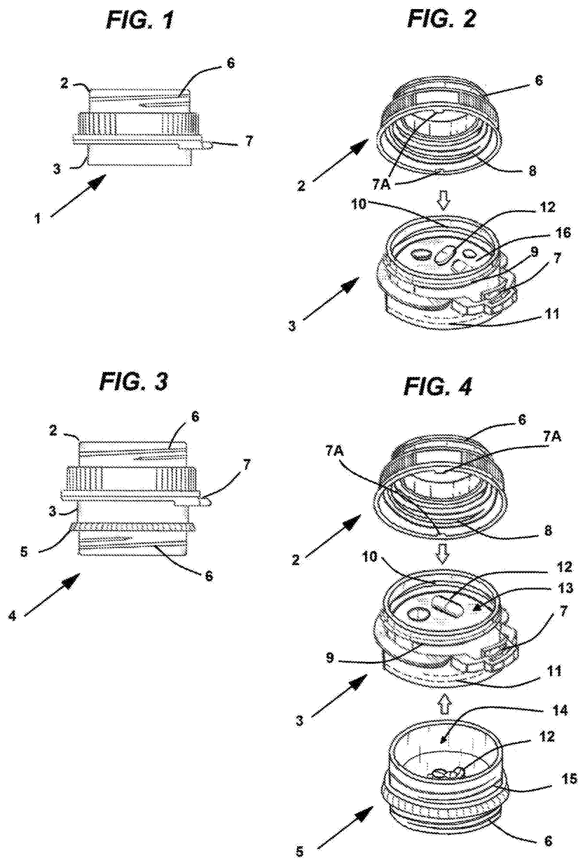

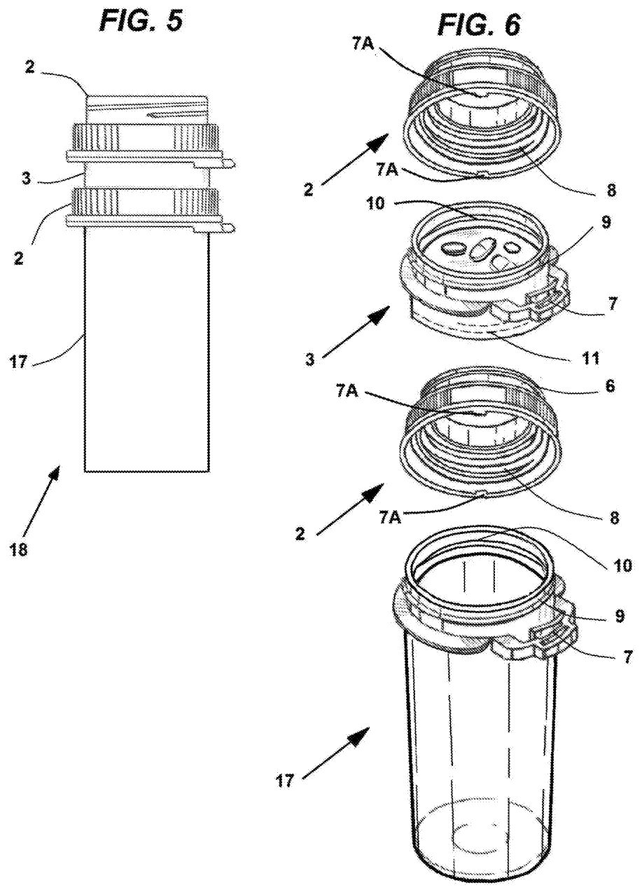

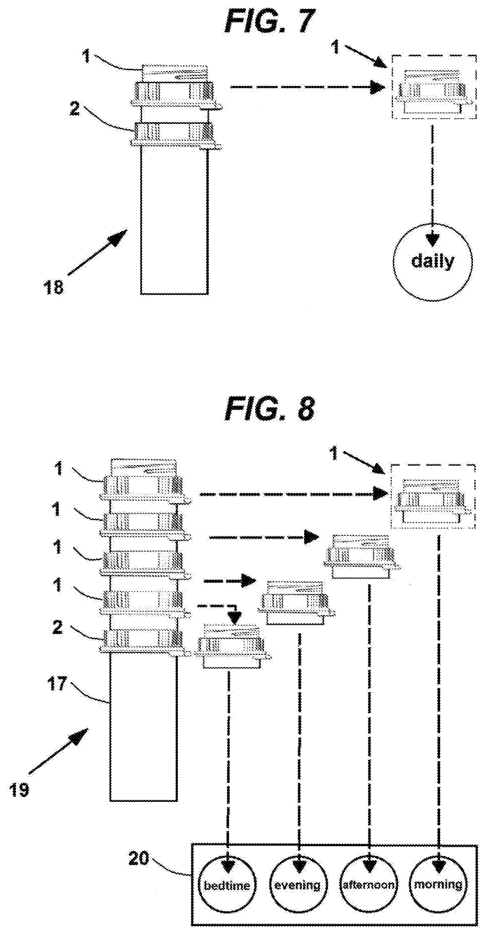

As shown in FIGS. 1-2, a portable dispenser 1 in accordance with one storage compartment embodiment of the present invention includes a dispenser reversible cap 2, which covers the dispenser body 3 with compartment 16 for pills' 12 storage. The dispenser cap 2 has external threading 6 and internal threading 8 and two internal lugs edge 7A. The dispenser body 3 has two internal threads 10, 11, and one external threading 9, and a lock mechanism 7 for a child-protected closure mode. The child-protected closure mode means that the lock mechanism 7; 7A provides secure mounting of the cap 2 to the dispenser body 3 and locks it in a manner which decreases risk and prevents children from being able to gain access to the interior of the container. Threads 6, 9, 10, and lock mechanism 7, 7A have the same measurements and functional parameters as the generic pill vial shown in FIG. 5-6 as cap 2 and cylindrical body 17. The lower portion of the dispenser body has an internal threading 11, which is compatible with external threading 6, enabling its attachment either to the reversible cap 2 of the generic pill vial or to the cap 2 of another portable dispenser 1.

FIGS. 3-4 the assembled view and exploded view are showing the various components of the portable dispenser with two storage compartments. The portable dispenser with two storage compartments 4 includes the upper cap 2, the dispenser body 3 (featuring the upper storage compartment), and the lower lid 5 for the second storage compartment 14. The lower lid 5 has external threading 15 which is compatible with internal threading 11 of dispenser body 3. The lid 5 also has external threading 6 which is compatible for closure with the internal threading of the reversible cap 2 to enable its attachment to reversible cap 2 in non-child-protected closure mode, to the cylindrical body 17 of the generic pill vial, on FIG. 5-6 shown as cap 2 and cylindrical body 17. Non-child-protected closure mode means that closing the cap 2 or the lid 5 by twisting the dispenser body 3 doesn't activate the locking mechanism 7; 7A which controls access to the internal contents of the container.

FIG. 5 is the assembled view of the portable dispenser, shown as cap 2 and body 3, when it is attached to the generic pill vial, shown as cap 2 and cylindrical body 17, and combined with it into a single assembly 18. This depicts the method designed to improve compliance with medication regimens with the aid of the portable dispenser 1 associating each portable dispenser with one of a plurality of generic pill vials with reversible caps, each comprising a same type of medication. FIG. 6 is the exploded view showing the various components of the generic pill vial, such as the reversible cap 2, the cylindrical body 17, and the portable dispenser components, such as cap 2 and body 3, which could be combined into a single assembly 18. The portable dispenser, shown as cap 2 and body 3, can be detached from the generic pill vial/medicine container, shown as cap 2 and cylindrical body 17, to accommodate a prepared daily dosage of pills, enabling the user to carry with them only the portable dispenser and to have their daily dosage of medication available to them anywhere anytime. Being associated through attachment (and possibly through distinct color as well) with the generic pill vial, the portable dispenser can also act as a method of monitoring and reminding: so that when it is empty, the user would realize that it is time to refill the portable dispenser with another daily dosage of items for the next day, or/and to bring with them another portable dispenser with their daily dosage of pills already prepared for the next day. Some portion of the portable dispenser 1, preferably the lower portion, which is shown as dispenser body 3, is transparent to expose to the user either the presence or the absence of their daily dose of items, without the user having to open the portable dispenser 1.

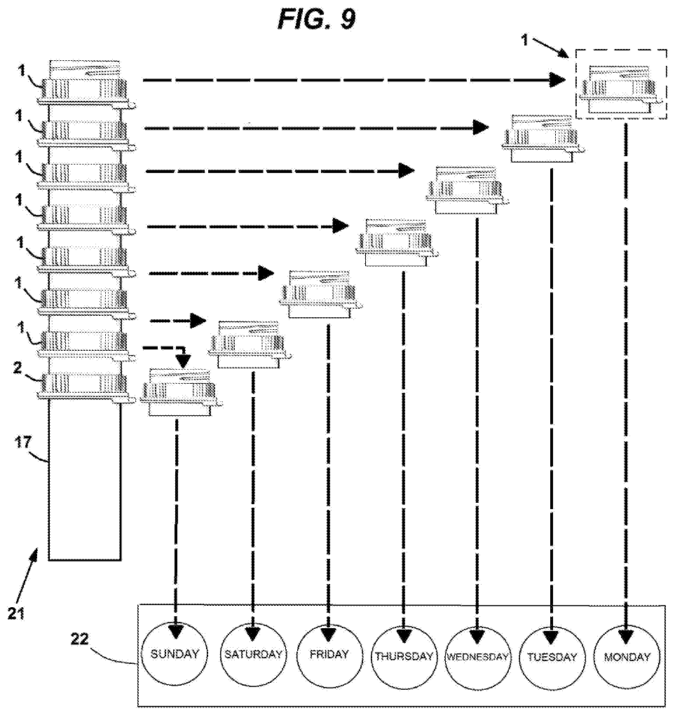

FIGS. 7-9 illustrate the method by which multiple portable dispensers 1 could be attached to each other, thus becoming assembled into a system 18, 19 for tracking recommended doses and regimens for the dispensing of medication, or of other items stored in the container 17 of the generic pill. The method designed to improve compliance with medication regimens with the aid of a portable dispenser system organizing towards specialized usage a plurality of portable dispensers 1, which can have corresponding labeling, distinct colors, transparent storage compartments. FIG. 7 is a view of the portable dispenser and the generic pill vial assembled into a stackable configuration 18, which illustrates a specific embodiment of the system and method for tracking recommended doses and regular regimens for the dispensing of medication, or of other items stored in the generic pill vial. FIG. 8 is a view of four portable dispensers 1 and one generic pill vial, shown as cap 2 and cylindrical body 17, assembled in stackable configuration 19 which illustrates a specific embodiment of the system and method for tracking recommended doses and daily regimens for dispensing medication or other items stored in the generic pill vial (shown as cap 2 and cylindrical body 17). FIG. 9 is a view of seven portable dispensers 1 and generic pill vial, shown as cap 2 and cylindrical body 17, assembled in stackable configuration 21 and which illustrates a specific embodiment of the system and method for the tracking of recommended doses and weekly regimen for the dispensing of medication or of other items stored in the generic pill vial. FIGS. 7-9 show that the portable dispenser 1 can be detached from the generic pill vial/medicine container to accommodate a prepared daily dosage of pills and to enable the user to carry a portable dispenser and to have their daily dosage of medication available to them anywhere anytime. Whenever the detached portable dispenser 1 is empty, the user would realize that it is time to refill the portable dispenser with a daily dose of items for the next day or know to take another portable dispenser 1 with their daily dosage of pills already prepared for the next day. The empty dispenser can be put in a dispenser holder organizer 20, 22 that would indicate which day of the week or time of the day corresponds with the taken dose.

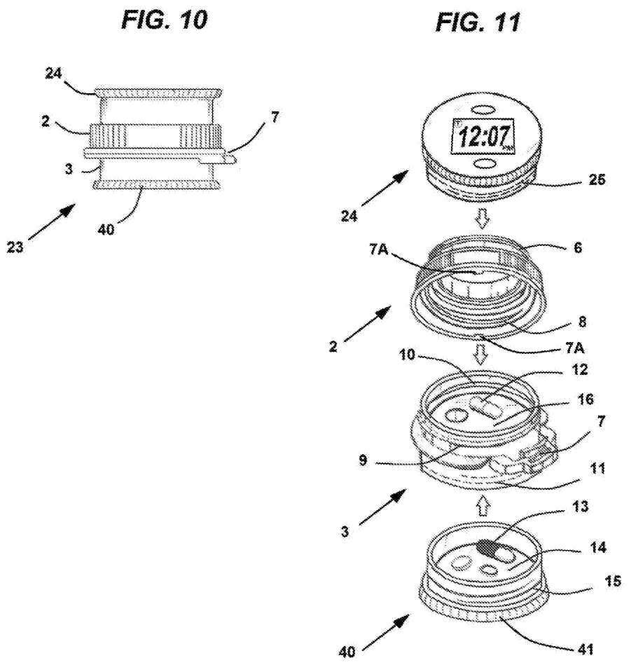

FIGS. 10-21 depict the method designed to improve compliance with medication regimens with the aid of a portable dispenser system assembling into a stackable interlocking configuration each of the electronic devices, as well as each of the portable dispensers corresponding to the details of one's medication dispensing regimen, as well as the generic pill vial itself. And also illustrate the system and the method of tracking compliance with concurrent medication regimens, types and dosages through a coherent singular system composed of a plurality of mutually-supportive tools and configurations, including the portable dispenser system.

FIG. 10 is a side elevation view of assembled portable dispenser 23 with two storage compartments and with a compact electronic device component 24. FIG. 11 is a perspective view of separate component parts of the portable dispenser with the electronic device, which includes an electronic device 24, the reversible cap 2, a dispenser cylindrical body 3 with upper storage compartment 16, the bottom lid 40 with the lower storage compartment 14 and with external bottom magnetic surface 41, which can also serve as an adapter to enable the attachment of the portable dispenser 23 to any metallic or magnetic surface. Due to the cap 2 of the portable dispenser 23 having the same measurements and functional parameters as the reversible cap of the generic pill vial, an electronic device 24 with internal threading 25 compatible with the external threading 6 of the reversible cap 2, can be attached to the generic pill vial or to the portable dispenser, becoming integrated for the purpose of providing automated regimen tracking functionality to the generic pill vial or/and to the portable dispenser.

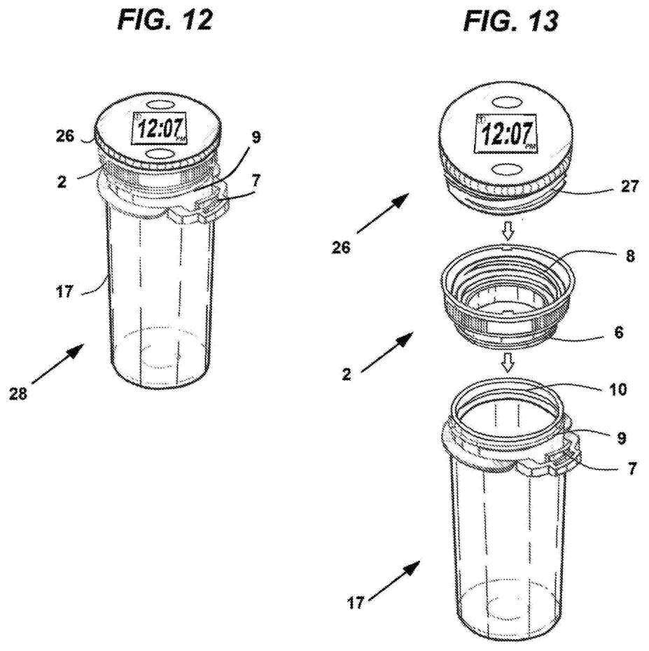

FIG. 12 is a perspective view of the generic pill vial with a compact electronic device component 28, where the electronic device 26 is assembled together with the reversible cap 2 which covers the cylindrical body 17 of the generic vial in non-child-protection closure mode. FIG. 13 is a perspective view of separate component parts of the generic pill vial assembled together with the electronic device and including the following components: the electronic device 26 with external threading 27, the reversible cap 2, shown as prepared to be closed in non-child-protection mode, and the storage container portion 17 of generic pill vial.

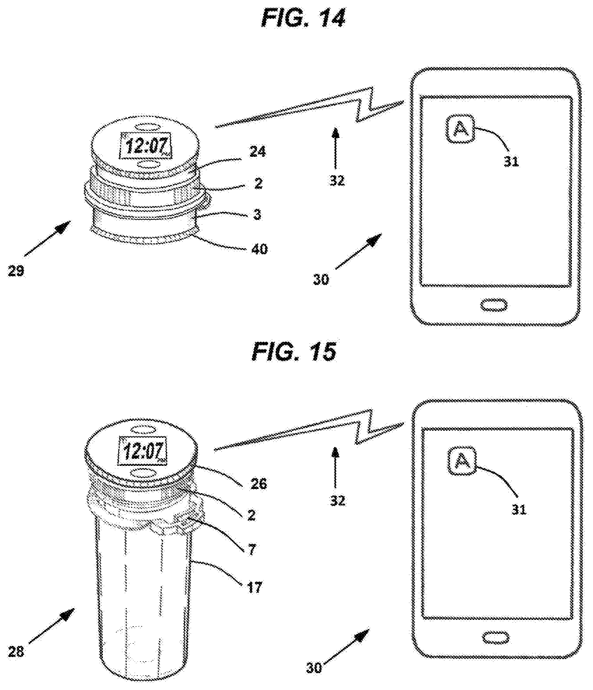

FIG. 14 is a perspective view of the portable dispenser 29 with a compact electronic device component 24, shown wirelessly connected to smartphone/computer device 30 by the means of a software application 31. FIG. 15 is a perspective view of the generic pill vial 28 with a compact electronic device component 26 shown wirelessly connected 32 to a smartphone/computer device 30 by the means of a software application 31. In some embodiments and applied configurations, the compact electronic device 24, 26 may perform the monitoring-reminder-alarm-operational functions and can, thus, be comprised of the following blocks of functionality: timer, clock, scheduler, calendar, sensing detector of an opening/closing dispenser state, sensing detector of the dispenser content and its volume, data memory, data processor, display of information, GPS, light alarm, noise alarm, vibration alarm, panel for manual configuration and operation, remote connection to smartphone/computer/computer device with a companion mobile application installed, remote configuration and operation through smartphone/computer/computer device with a companions software application installed, remote notification through smartphone/computer/computer device with software application, internal batteries, and/or power supply. Being physically integrated via attachable components and its distinctly matched color with the generic pill vial and formally associated with particular types of pills inside of the vial through electronic device settings and/or the settings of the companion software application 31 installed on the smartphone/computer device 30, the compact electronic device 24, 26 enables monitoring, reminders, and alerts to help maintain the user's awareness of and compliance with their medication regimen. In some embodiments, the software application 31—which is hosted on one or more types of electronic devices 30, such as smartphones/computers, tablets, laptops—performs specific functions through cross-platform analogous companion applications' standardized Main Menu page, which displays recent alarms, notifications, detected issues, and the status of monitored objects and gives access to the following main functions and dashboards, such as: Application Settings, Monitoring System Configuration, Sensors Provisioning, Real-Time Reporting, Historical Reporting and Analytics, Monitored Objects, About, and Contact Support. The smartphone/computer device 30 with software application 31 and the electronic device 24, 26 are paired through RF wireless connection 32 for data exchange, preferably using Bluetooth protocol.

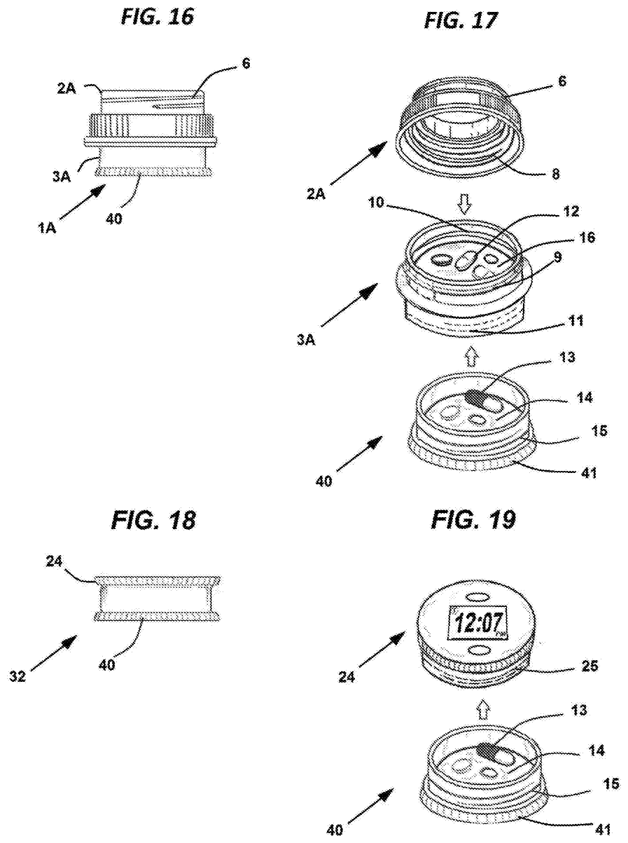

FIGS. 16-17 demonstrate the portable dispenser embodiment 1A (a side elevation view of a portable dispenser), 2A, 3A, 40 (a perspective views of three separate component parts of the portable dispenser without a lock embodiment) with a magnetic bottom surface 41 and without the lock mechanism 7; 7A. The embodiment without the lock mechanism 7; 7A assumes that the portable dispenser doesn't feature the child-protected closure mode. The embodiment implemented with the magnetic threaded adapter 40 enables the portable dispenser 1 to become attachable to any metallic-magnetic surface, such as the Calendar Magnetic Board.

FIGS. 18-19 demonstrate an embodiment of the compact electronic device 24; 32 with a magnetic bottom surface 41 and implemented with a magnetic threaded adapter 40. The embodiment with a magnetic bottom surface 41 enables the compact electronic device 24, 32 to become attachable to any metallic-magnetic surface, either while it is assembled together with the portable dispenser 1 or autonomously from the portable dispenser 1.

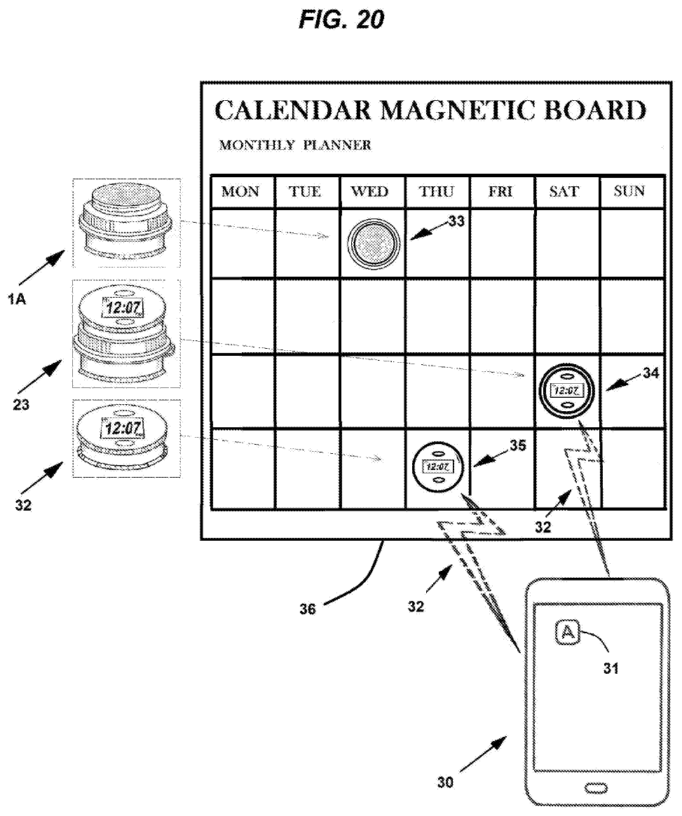

FIG. 20 depicts the method of providing preconditioning compliance with medication regimen via the portable dispenser's magnetically attachable calendar base, via attachable electronic reminder-alarm device, via the mobile application wirelessly communicating with the attachable electronic device, or via the combined usage of the portable dispenser, the magnetic calendar, the electronic device, the mobile application when all of them or some of them being assembled in the system via attachment to each other and via corresponding electronic device settings and via mobile application and the smartphone/computer device configuration. FIG. 20 is a perspective views of three embodiments 1A, 23, 32 of the portable dispensers and the compact electronic devices with magnetic threaded adapters 40 which are attachable to the Calendar Magnetic Board 36, intended for medication regimen tracking purposes. The dispenser holder organizer 20, 22 may alternatively be designed to serve as a portable version of the Calendar Magnetic Board 36 with the possibility of attaching the portable dispenser(s) 1 or/and the electronic device(s) 24 to it by the means of threaded magnetic adapters 40, which being compatible with internal threading 11, 25. The portable dispensers 1, the compact electronic device 24, and the threaded magnetic adapter 40 can be attached together, composing embodiments 1A, 23, 32, and then become attached to a Calendar Magnetic Board 36 to help the user comply with their medication regimen by the means of an association between their daily dosage and the date on the calendar, as well as the corresponding aid of electronic device alarms and the mobile application 31 wirelessly communicating 32 with the attachable electronic devices 34, 35. This drawing illustrates the method of providing preconditioning compliance with medication regimentation via the portable dispenser 1, via the Calendar Magnetic Board 36, via attachable electronic reminder-alarm device 24, via the mobile application 31 wirelessly communicating 32 with the electronic device 24, or via the combined usage of the portable dispenser 1, the magnetic calendar 36, the electronic device 24, and the mobile application 31, when all of them, or some of them, are assembled into a system by being attached to each other, as well as through corresponding electronic device settings, and through the configuration of mobile application and the smartphone/computer device. Positioning of the embodiments 1A, 23, 32, attached to the Calendar Magnetic Board, corresponds to prescribed medication weekly regimen and is associated with timer-alarm settings of the electronic devices and with calendar of the mobile application.

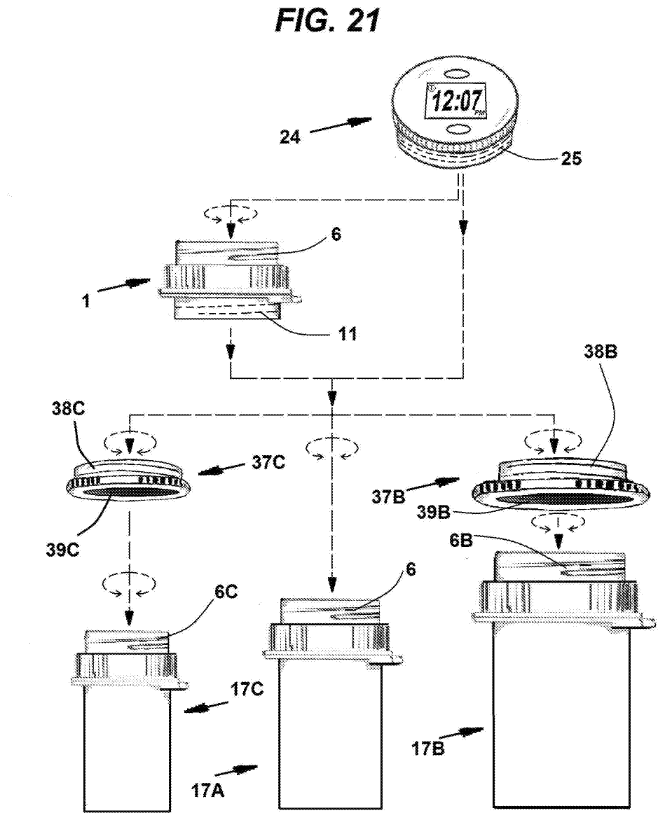

FIG. 21 is side elevation and perspective views of the portable dispenser 1, the compact electronic device 25, and generic pill vials of three different sizes 17A, 17C, 17B, which are combined in a connectivity diagram to illustrate attachability of the portable dispenser 1 and the compact electronic device 24 to generic pill vials of two different sizes 17B, 17C, through two threaded adapters 37B, 37C. The attachable threaded adapters 37B, 37C with one external threading 38B, 38C, compatible with the internal threading 11, 25 of the portable dispenser 1 and electronic device 24, and one internal threading 39B, 39C, compatible with the external threading of the reversible cap of the generic pill vial 6B, 6C. If the diameter of a generic pill vial's reversible cap is not compatible with the system, the threaded adapters 37B, 37C will enable the attachment of the portable dispenser 1 and/or the electronic device 24 to the pill vial 17A, 17B despite the incompatibility of its reversible cap size. There are at least three standard sizes of pill containers with reversible caps commonly used by the pharmaceutical industry: “small” for 13-16 pills 17C, “medium” for 20-30 pills 17A, and “large” for 40-60 pills 17B. The portable dispenser 1 and compact electronic device 24 are directly compatible with the generic reversible cap threading 6 of the “medium” size standard container for 20-30 pills 17A through their internal threading 11, 25. As for containers for 13-16 pills 17C and for 40-60 pills 17B, the portable dispenser must be made compatible with them by the means of threaded adapters—for the “large” size 37B and for the “small” size 37C—with corresponding sizes of threading 39B, 39C.

Although the various embodiments have been described with reference to the drawings, the present invention is not limited to such realizations. It is obvious that a person skilled in this craft can conceive of various modifications or alterations within the scope recited in the description, and thus it is understood that they naturally fall within the scope of the present method. So that other embodiments, system configurations and methods may be foreseen from the description of the invention. For example, the method of attachment through external thread to the top of cap or lid, which was described in the current invention, can be applicable to any cylindrical-shape vial, container or bottle packaging, and not solely to reversible cap of the pill vial shown in the drawings. It should be understood that the various features, aspects and functionality described in one or more of the individual embodiments and configurations are not limited in their applicability to the particular embodiment with which they are described, but instead can be applied, alone or in various combinations, to one or more of the other embodiments of the application, whether or not such embodiments are described and whether or not such features are presented as being a part of a described embodiment. While various embodiments of the present disclosure have been described above, it should be understood that they have been presented by way of example only, and not of limitation. Thus, the breadth and scope of the present application should not be limited by any of the above-described exemplary embodiments and configurations.

What is claimed is:

1. A portable dispenser, for assorted pills or other items, with one storage compartment comprising: a cylindrical body with one storage compartment to hold pills or other items; a reversible cap that covers an open end of the cylindrical body; the reversible cap has one internal threading compatible with the cylindrical body's external threading, for closure, and one external threading compatible with dispenser cylindrical body internal threading, for closure in reverse position; the dispenser body, on one of its two cylindrical sides, has an open end with one external threading positioned on its external surface, which is compatible for closure with the internal threading of the reversible cap, and one internal threading positioned on its internal surface, which is compatible for closure with the external threading of the reversible cap; the dispenser body, on its second cylindrical side, has another open end with one internal threading, which is positioned on its internal surface and is compatible with the external threading of the reversible cap, enabling the attachment of the portable dispenser to the whole generic pill vial/container via interlocking with its reversible cap.

2. A portable dispenser for assorted pills or other items, with two storage compartments comprising: a cylindrical body with two partitioned storage compartments to hold pills or other items; a reversible cap that covers an open end of the first storage compartment; a reversible lid that covers an open end of the second storage compartment; the reversible cap having one internal threading compatible with the cylindrical body external threading for closure and one external threading compatible with the cylindrical body internal threading for closure in reverse position; the dispenser body, one of its two cylindrical sides, has an open end with one external threading, which is positioned on its external surface and is compatible with the internal threading of the reversible cap and one internal threading, which is positioned on the internal surface and is compatible with the external threading of the reversible cap; the dispenser body, on its second cylindrical side, has an open end with one internal threading positioned on the internal surface and is compatible with the external threading of the lid for the second storage compartment; the reversible lid for the second storage compartment has two external threads positioned on the external surface of the lid, which are both compatible with the cylindrical body internal threading for closure to cover an open end of the second storage compartment either in normal or in reverse mode.

3. The portable dispenser for assorted pills or other items as defined in claim 1, further comprising: an attachable lid with an external magnetic surface positioned at the bottom of the portable dispenser, with one external threading compatible with the cylindrical body's internal threading for closure. The attachable lid covers an open end of the cylindrical side of the dispenser body and can also serve as a magnetic adapter to enable the attachment of the portable dispenser to any metallic or magnetic surface.

4. The portable dispenser for assorted pills or other items as defined in claim 1 and in claim 2, further comprising: a lock mechanism, positioned on the dispenser cylindrical body and on one side of the reversible cap, and providing a child resistant closure by connecting one side of the reversible cap with the open end of the dispenser cylindrical body.

5. The portable dispenser for assorted pills or other items as defined in claim 1 and in claim 2, further comprising: an attachable threaded adapter with one external threading, compatible with the internal threading of the cylindrical body, and one internal threading, compatible with the external threading of the reversible cap of the generic pill vial. If the diameter of a generic pill vial's reversible cap is not compatible with the system, this will enable the attachment of the portable dispenser to the pill vial despite the incompatibility of its cap size.

6. The portable dispenser for assorted pills or other items as defined in claim 1 and in claim 2, further comprising: an attachable electronic device with monitoring-reminder-alarming functionality and with internal threading compatible with the external threading of the reversible cap, which enables the electronic device to be attached to either the portable pill dispenser or to the generic pill vial.

7. A system for compliance with medication regimen using an attachable portable dispenser, the system comprising: an attachable portable dispenser with reversible cap for assorted pills; an attachable electronic device; a generic prescription pill vial with a reversible cap;

8. The system for compliance with medication regimen using an attachable portable dispenser as defined in claim 7, further comprising: a smartphone/computer device with a software application;

9. The system for compliance with medication regimen using an attachable portable dispenser as defined in claim 7, further comprising: an attachable threaded adapter;

10. The system for compliance with medication regimen using an attachable portable dispenser as defined in claim 7, further comprising: a magnetic threaded adapter;

11. The system for compliance with medication regimen using an attachable portable dispenser as defined in claim 7, further comprising: a magnetic calendar;

12. The system of claim 7, wherein the portable dispenser is attachable via reversible cap to other analogous portable dispensers or to a generic pill vial;

13. The system of claim 7, wherein the portable dispenser features at least one or more storage compartments;

14. The system of claim 7, wherein the attachable electronic device enables monitoring-reminder-alarming functionality for regimen control and can be wirelessly connected to the smartphone/computer device with a software application.

15. The system of claim 8, wherein the smartphone/computer device with a software application enables remote monitoring of at least one or more attachable electronic devices via wireless connection, providing user with remote monitoring-reminder-alarming-location-reporting functionality for regimen control.

16. The system of claim 9, wherein the attachable threaded adapter enables the attachment of the portable dispenser to a generic pill vial with incompatible reversible cap diameter;

17. The system of claim 10, wherein the magnetic threaded adapter enables the attachment of the portable dispenser to a magnetic calendar board for the purpose of regimen control;

18. A method designed to improve compliance with medication regimens with the aid of a portable dispenser system, the method comprising: organizing towards specialized usage a plurality of portable dispensers, which can have corresponding labeling, distinct colors, transparent storage compartments, and attached configured electronic device with monitoring-reminder-alarming functionality; associating each portable dispenser with one of a plurality of generic pill vials with reversible caps, each comprising a same type of medication; providing preconditioning compliance with medication regimen via the portable dispenser's magnetically attachable calendar base, via attachable electronic reminder-alarm device, via the mobile application wirelessly communicating with the attachable electronic device, or via the combined usage of the portable dispenser, the magnetic calendar, the electronic device, and the mobile application, when all of them, or some of them, are assembled into a system by being attached to each other, as well as through corresponding electronic device settings, and through the configuration of mobile application and the smartphone/computer device; assembling into a stackable interlocking configuration each of the electronic devices, as well as each of the portable dispensers corresponding to the details of one's medication dispensing regimen, as well as the generic pill vial itself; tracking compliance with concurrent medication regimens, types and dosages through a coherent singular system composed of a plurality of mutually-supportive tools and configurations, including the portable dispenser system;
